(19) United States
(12) Patent Application Publication
(10) Pub. No.: US 2006/0151891 A1
(43) Pub. Date: Jul. 13, 2006

(54) VENTURI INDUCTION FOR HOMOGENEOUS CHARGE COMPRESSION IGNITION ENGINES

(75) Inventor: James M. Meyer, Morrison, CO (US)

Correspondence Address: ASPEN ENGINEERING SERVICES, LLC, 8425 DOUBLEHEADER RANCH ROAD, MORRISON, CO, 80465, US

(73) Assignee: ASPEN ENGINEERING SERVICES, LLC, Morrison, CO (US)

(21) Appl. No.: 10/905,637

(22) Filed: Jan. 13, 2005

(51) Int. Cl. F02M 19/08

(52) U.S. Cl. 261/18.2; 261/DIG. 12; 261/DIG. 56

(57) ABSTRACT

Ambient air is fed through a double wall pipe exhaust and subsequently directed into a pintle regulated Venturi. Fuel is vaporized and mixed homogeneously with air in the Venturi throat. The mixture is homogeneous at all throttle loadings because the pintle flow regulating valve maintains a high velocity at the Venturi throat. Water is injected into the Venturi throat to regulate the air/fuel charge temperature and, consequently, auto-ignition timing for a Homogeneous Charge Compression Ignition (HCCI) engine.

### SUMMARY OF THE INVENTION

This invention relates to heating charge air and the mixing of air, fuel and water using Venturi to deliver a temperature controlled charge to a Homogeneous Charge Compression Ignition (HCCI) engine. The well-mixed charge provides the homogeneous mixture necessary for compression ignition and mitigates an inherent problem of fuel stratification on internal surfaces. Fuel could be gasoline but could also be natural gas, other hydrocarbons, alcohols, or diesel. The invention recovers heat energy from the exhaust and improves combustion due to enhanced mixing, resulting in improved combustion and fuel economy.

### BACKGROUND OF THE INVENTION

Homogeneous Charge Compression Ignition (HCCI) engines operate by auto-igniting a heated fuel/air mixture by engine compression. The advantage of a HCCI engine includes low NOx emission resulting from the short combustion time and greater engine efficiency than a spark ignited engine. Challenges to HCCI engine design include unburned hydrocarbon emissions caused by fuel stratification on internal engine surfaces and auto-ignition timing.

Of the six pollutants (carbon monoxide, lead, nitrogen oxides, particulate matter, sulfur dioxide, and volatile organic compounds) tracked by the Environmental Protection Agency, all have decreased significantly since passage of the Clean Air Act in 1970—except for nitrogen oxides

Air is composed of 78 volume percent nitrogen. Nitrogen oxidizes when fuel is burned at high temperatures, as in a combustion process to form nitrogen oxides. Nitrogen oxides consist of a group of oxidized nitrogen compounds collectively known as NOx. Many of the nitrogen oxides are colorless and odorless. However, one common pollutant, nitrogen dioxide (NO₂) along with particles in the air can often be seen as a reddish-brown layer over many urban areas. The primary source of NOx is motor vehicles. Production of NOx increases with the time and temperature of combustion.

The differential producing Venturi has a long history of uses in many applications. With no abrupt flow restrictions, the Venturi can mix gases and liquids with a minimal total pressure loss. Recently, the Venturi has been used in carbureted engines. The suction from the throat of the Venturi provided the motive force for bringing the fuel in contact with the air. The improved application of the Venturi with the proposed invention is: the metering of the fuel is controlled by the fuel injector instead of the suction of the venturi; the fuel vaporization is facilitated by the reduced pressure in the throat of the Venturi; and mixing of the fuel/air mixture is further facilitated by the turbulent action in the outlet of the Venturi.

The principle behind the operation of the Venturi is the Bernoulli effect. The Venturi mixes vapors and liquids by reducing the cross sectional flow area in the air flow path, resulting in a pressure reduction in the throat of the Venturi. After the pressure reduction, the mixture is passed through a pressure recovery exit section where most of the pressure reduction is recovered. The pressure differential follows Bernoulli's Equation, simplified for a negligible change in elevation:
P₁+1/2d₁v₁²=P₂+1/2d₂v₂²

where,

P₁=Pressure at the inlet of Venturi (FIG. 1, location 101);

P₂=Pressure at the throat of the Venturi (FIG. 1, location 102);

d₁=air density at the inlet of the Venturi (FIG. 1, location 101);

d₂=air density at the throat of the Venturi (FIG. 1, location 102);

v₁=air velocity at the inlet of the Venturi (FIG. 1, location 101) and;

v₂=air velocity at the throat of the Venturi (FIG. 1, location 102).

In FIG. 1, the air enters the Venturi at the location 101 with a cross-sectional area A₁, pressure P₁, and velocity v₁. These properties form the potential and kinetic energy of the fluid at one location. Energy is conserved in a closed system, that is, the sum of potential and kinetic energy at one location must equal the sum of the potential and kinetic energy at any another location in the system. If potential energy decreases at one location, the kinetic energy must proportionally increase at that location. The fluid enters the throat of the Venturi at location 102 with a new area A₂, which is smaller than A₁. In a closed system mass can be neither created nor destroyed (law of conservation of mass), and as such, the volumetric flow rate at area A₁ must equal the volumetric flow rate at area A₂. If the area at location A₂ is smaller than A₁, the fluid must travel faster to maintain the same volumetric flow rate. This increase in velocity results in a decrease in pressure according to the Bernoulli's equation.

### BRIEF DESCRIPTION OF THE DRAWINGS

FIG. 1 is a flow diagram for a typical Venturi.

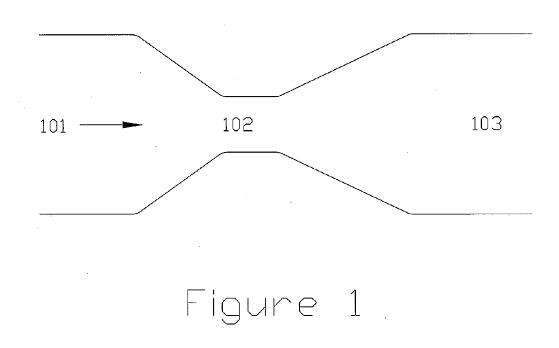

FIG. 2 is a diagram of a fuel/air intake passage improved by enhanced by the utilization of an unregulated Venturi.

FIG. 3 is a diagram of a fuel/air/water delivery system using a Venturi with an integrated throttle design to regulate the flow of air into the engine.

FIG. 4 is a process flow diagram of a HCCI induction system with exhaust-heated air and a fuel/air/water Venturi delivery system.

FIG. 5 is a process flow diagram of a HCCI induction system with exhaust-heated turbocharged air and a fuel/air/water Venturi delivery system.

FIG. 6 is a process flow diagram of a HCCI induction system with exhaust-heated supercharged air and a fuel/air/water Venturi delivery system.

### DETAILED DESCRIPTION

This disclosure offers solutions to the two main challenges of HCCI engines: 1) timing of the auto-ignition and 2) residual hydrocarbon emissions resulting from fuel stratification on internal surfaces of the combustion chamber.

Auto-ignition timing is accomplished by controlling the mixture charge temperature with a water injection stream. Specifically, water is injected into the throat of the Venturi where homogeneous mixing is accomplished with fuel and air. Air is defined for the purposes of this disclosure as a vapor containing oxygen. Water is defined as liquid containing water, recognizing that anti-freeze components may be required for cold weather operation. The mixture temperature is lowered because of the low water temperature relative to the hot air charge and because of the latent heat of evaporation of the water. The temperature of the homogeneous charge then changes the ignition timing during the compression stroke. The water injection rate is controlled by the engine controls similar to the control of the spark in a conventional stratified charge engine. By changing the temperature of the charge mixture, auto-ignition timing can be controlled.

Residual fuel combusted on internal surfaces of the combustion chamber is mitigated by pre-mixing fuel and air immediately before delivering the mixed charge to the combustion chamber. A Venturi regulated by a pintle valve provides a high velocity at the mixing point regardless of the throttle position. For example, when a car is cruising down the highway at low throttle, the pintle is relatively closed into the throat of the Venturi. Consequently, the mixing velocity is much higher and mixing is more complete relative to an unregulated Venturi or a common butterfly throttle valve induction system.

Engine efficiency is improved by exchanging heat from the exhaust with charge air. Excess heat is absorbed by the latent heat of evaporation of water fed into the engine. Exhaust heat is therefore recovered by the phase change of water from the liquid phase in the Venturi feed to the vapor phase out the engine exhaust.

The vaporization of the fuel is improved in the Venturi throat by the heat transfer from the hot charge air. Gasoline is typically only 68% vaporized at 70 degrees Fahrenheit. A typical exhaust manifold temperature is about 450 degrees Fahrenheit. Consequently, there is sufficient heat available to substantially raise the fuel/air mixture temperature. The pre-heated air and Venturi mixing concept complement one another, resulting in better fuel/air pre-mixing because of the reduced pressure and increased turbulence at the throat of the Venturi. The result is improved fuel economy and engine performance.

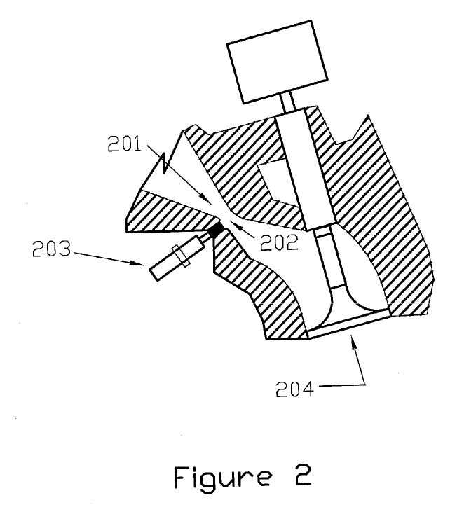

FIG. 2 illustrates an internal combustion engine intake system with an unregulated Venturi delivery system. Air 201 flows into the Venturi either from natural engine suction or pressurized flow from a supercharger or a turbocharger. The air flows into the Venturi throat 202 where the pressure is reduced according to the Bernoulli equation. Fuel is metered into the throat of the Venturi with a fuel injector 203. The mixed fuel/air mixture leaves the Venturi and enters the combustion chamber through the intake valve 204

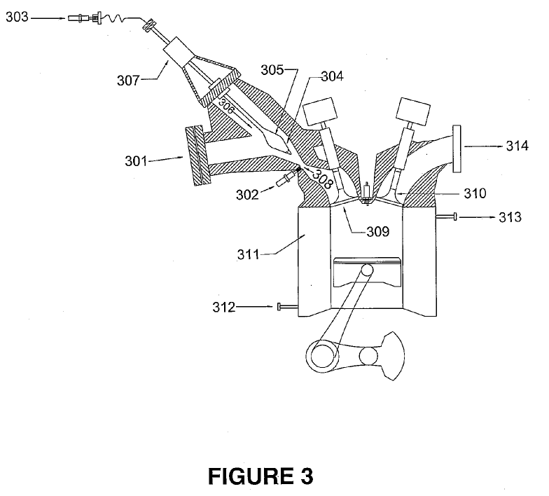

FIG. 3 illustrates a regulated fuel/air delivery system consisting of a Venturi and integrated pintle throttle design. Air 301 flows into the Venturi either from engine suction, or pressurization from a supercharger or turbocharger. The air rate is regulated by the pintle throttle 305. The position of the throttle is modulated by an actuator 307 and moves 306 as required by the engine controls. The air flows into the Venturi throat 308 where the pressure is reduced according to the Bernoulli equation. Fuel is metered into the throat of the Venturi with a fuel injector 302. The fuel can be introduced from a fixed location as indicated in FIG. 3 or introduced through the pintle throttle 305. The mixed fuel/air mixture leaves the Venturi and enters the combustion chamber through the intake valve 309. The spark plug shown is not used during HCCI operation but is depicted for hybrid engines requiring stratified charge combustion.

Water is injected into the combustion chamber via the Venturi through injector 303 and the pintle openings 304 as required by the engine controls for auto-ignition timing. Although FIG. 3 shows a water injector upstream of the pintle, the water injector could be positioned inside the pintle to facilitate dispersion of the water into the Venturi. Exhaust leaves the combustion chamber through exhaust valve 310 and leaves the engine through the manifold 314. A typical liquid-cooled engine design is depicted with cooling chamber 311, coolant inlet 312 and coolant outlet 313 although the concept is applicable to air-cooled engines.

With the regulated Venturi design, the fuel becomes well mixed with the air because: 1) the reduction in pressure at the throat of the Venturi increases the partial pressure of the fuel and promotes vaporization of the fuel and; 2) turbulence through the Venturi facilitates fuel/air mixing before the combustion chamber.

The pintle regulated Venturi design promotes enhanced fuel/air mixing at all throttle air rates by incorporating the air flow control with the Venturi design. The resulting flow area reduction provides a higher velocity at low throttle than an unregulated Venturi design. Consequently, the air velocity is always high into the throat of the Venturi, improving fuel/air mixing over the entire throttle range.

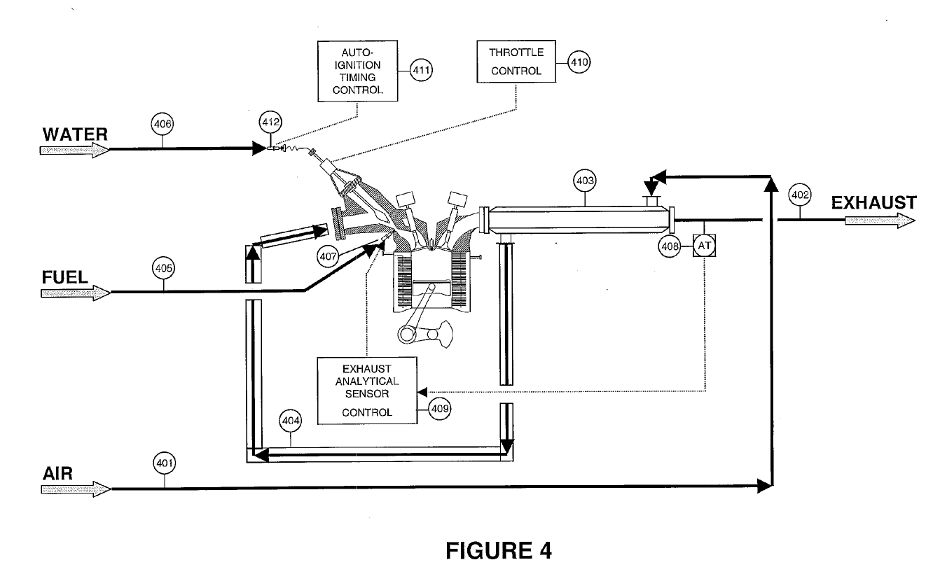

FIG. 4 depicts charge air 401 being heated by the exhaust 402 using a double wall exhaust pipe 403. The heat of the air is retained by passing the heated charge air through an evacuated double wall pipe 404 or a well insulated pipe to the Venturi. The fuel rate through the fuel injector 407 is controlled by the exhaust analytical sensor 408 and the analytical sensor control 409 in the engine computer. The air rate is controlled by the throttle 410. Auto-ignition timing is controlled by the engine sensors 411, regulating the water rate through the water injector 412. The combined air, water and fuel charge is homogeneously mixed in the Venturi and cooled by water injection. Consequently, the timing of the auto-ignition is controlled by the water injection rate.

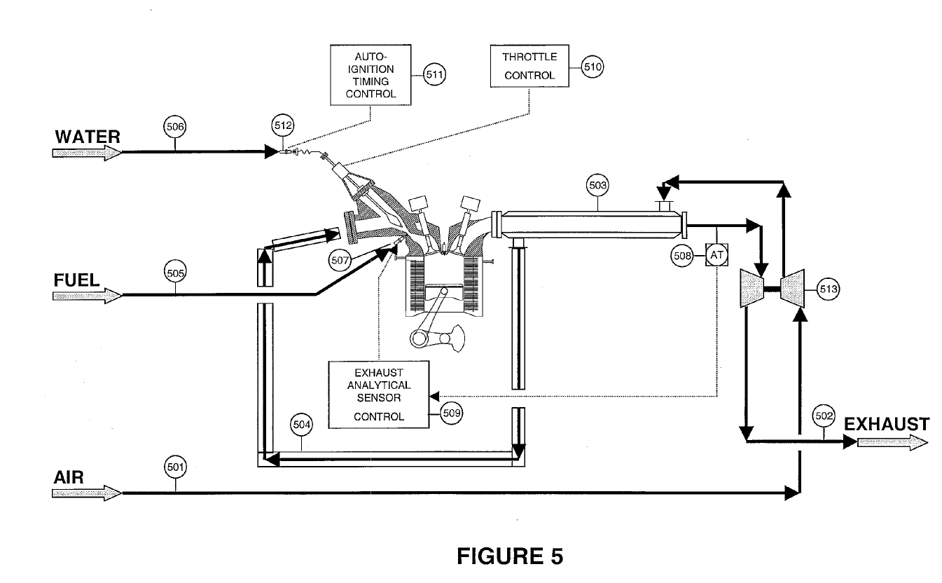

FIG. 5 includes a turbocharger 513 to overcome frictional losses in the double wall pipe. The additional pressure from the turbocharger facilitates mixing in the Venturi. Charge air 501 is heated by the exhaust 502 using a double wall exhaust pipe 503. The heat of the air is retained by passing the heated charge air through an evacuated double wall pipe 504 or a well insulated pipe to the Venturi. The fuel rate through the fuel injector 507 is controlled by the exhaust analytical sensor 508 and the analytical sensor control 509 in the engine computer. The air rate is controlled by the throttle 510. Auto-ignition timing is controlled by the engine sensors 511, regulating the water rate through the water injector 512. The combined air, water and fuel charge is homogeneously mixed in the Venturi and cooled by water injection. Consequently, the timing of the auto-ignition is controlled by the water injection rate.

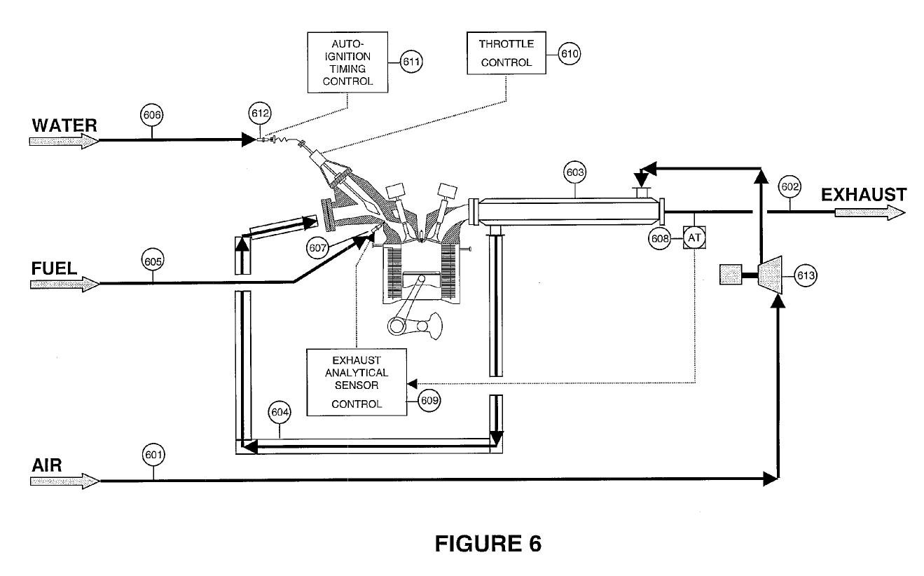

FIG. 6 includes a supercharger 613 to overcome frictional losses in the double wall pipe. The additional pressure from the supercharger facilitates mixing in the Venturi. Charge air 601 is heated by the exhaust 602 using a double wall exhaust pipe 603. The heat of the air is retained by passing the heated charge air through an evacuated double wall pipe 604 or a well insulated pipe to the Venturi. The fuel rate through the fuel injector 607 is controlled by the exhaust analytical sensor 608 and the analytical sensor control 609 in the engine computer. The air rate is controlled by the throttle 610. Auto-ignition timing is controlled by the engine sensors 611, regulating the water rate through the water injector 612. The combined air, water and fuel charge is homogeneously mixed in the Venturi and cooled by water injection. Consequently, the timing of the auto-ignition is controlled by the water injection rate.

What is claimed is:

1. A double wall exhaust pipe carrying exhaust inside the center pipe heats charge air flowing through the annulus, whereby hot charge air is provided to a Homogeneous Charge Compression Ignition (HCCI) engine.

2. A double wall evacuated pipe transfers heated charge air to the engine intake, whereby heat losses are minimized for charge air to a HCCI engine.

3. A Venturi passing charge air with fuel injected into said Venturi mixes fuel and air due to the reduced pressure at the throat of the Venturi and due to the turbulence through the Venturi; whereby a well-mixed fuel and air mixture is delivered to a HCCI engine.

4. A pintle throttle incorporated into the Venturi of claim 3, providing a variable Venturi throat area; fuel is injected into either the side of the Venturi or is injected through the pintle; whereby fuel and air is well mixed throughout the throttle range to a HCCI engine.

5. Water is mixed with fuel and air, the temperature of the resulting mixture delivered to the engine is controlled by the water injection rate; whereby auto-ignition timing of a HCCI engine is controlled.

6. Water as described in claim 5 is injected into the side of the Venturi or through the pintle causing a well-mixed fuel/air/water charge; whereby fuel, air and water is well mixed throughout the throttle range to a HCCI engine.
